(19) United States
(12) Patent Application Publication
(10) Pub. No.: US 2012/0236102 A1
(43) Pub. Date: Sep. 20, 2012

(54) METHOD FOR MANUFACTURING ELECTRONIC COMPONENT, METHOD FOR MARKING SAME, AND DEVICE FOR MARKING SAME

(75) Inventor: Masahisa OTAKE, Chino (JP)

(73) Assignee: SEIKO EPSON CORPORATION, Tokyo (JP)

(21) Appl. No.: 13/420,900

(22) Filed: Mar. 15, 2012

(30) Foreign Application Priority Data
Mar. 17, 2011 (JP) 2011-059057
Mar. 17, 2011 (JP) 2011-059058

(51) Int. Cl. B41J 2/00; B05D 3/06; B05D 3/02; B05D 5/00

(52) U.S. Cl. 347/110; 427/510

(57) ABSTRACT

A method for manufacturing an electronic component includes: applying a liquid body onto an electronic component to perform marking, with the liquid body having a light-curing property and containing N-vinyl caprolactam within a range of 5 wt % or more; irradiating light on the liquid body applied onto the electronic component under a predetermined condition; and heating the liquid body after the irradiating of the light.

### CROSS-REFERENCE TO RELATED APPLICATIONS

This application claims priority to Japanese Patent Application No. 2011-059057 filed on Mar. 17, 2011 and Japanese Patent Application No. 2011-059058 filed on Mar. 17, 2011. The entire disclosures of Japanese Patent Application Nos. 2011-059057 and 2011-059058 are hereby incorporated herein by reference.

### BACKGROUND

1. Technical Field

The present invention relates to a method for manufacturing an electronic component to be marked, a method for marking an electronic component or another member to be processed, and a marking device used in the method for manufacturing an electronic component and the marking method.

2. Related Art

Conventionally, electronic components created by packaging an integrated circuit (IC) or a similar structure are used in a variety of instruments, and electronic components of such description are subjected to marking, in which characters, symbols, logos, and other marks are printed. The inkjet method is an example of a known method for performing such marking. The inkjet method is a configuration in which ink is ejected only onto a location to be marked on the electronic component, and has characteristics in which ink can be used in an efficient manner.

As an example of marking using the inkjet method, there is disclosed in Japanese Laid-Open Patent Application Publication No. 2006-21479 a method for inkjet recording used in manufacture of a printed substrate, characterized in that the cumulative light dose and the brightness of UV light irradiation is set within a specific range so that ink containing titanium dioxide is cured at a maximum ink film thickness of 10 to 30 μm. Also, in Japanese Laid-Open Patent Application Publication (Translation of PCT Application) 2007-527459, there is disclosed an inkjet printing method characterized in including: a step for spraying an UV-curing ink containing a colorant, a photopolymerization initiator, and an epoxy reagent from an inkjet printer onto a printed circuit board and providing marking; and a step for exposing the marking to UV light at least two seconds later.

### SUMMARY

However, according to the recording (printing) methods disclosed in the above described publications, problems are presented in that the state of quality of ink treated by, e.g., setting a specified range is unclear, and that at least one of abrasion resistance, adhesion performance, and alcohol resistance of a marking placed using this ink is poor or requires improving in terms of quality stability and other issues. In other words, there are instances in which application is difficult for an electronic component that is placed under conditions that are harsh in terms of temperature or other factors.

The present invention was devised in order to solve at least some of the above-mentioned problems, and can be realized as the following application examples or embodiments.

A method for manufacturing an electronic component according to one aspect of the present invention includes: applying a liquid body onto an electronic component to perform marking, the liquid body having a light-curing property and containing 5 wt % or more of N-vinyl caprolactam; irradiating light on the liquid body applied onto the electronic component at a cumulative light dose equal to or greater than 200 mJ/cm²; and heating the liquid body after the irradiating of the light.

According to this method for manufacturing an electronic component, a liquid body containing 5 wt % or more of N-vinyl caprolactam is used for marking the electronic component. This liquid body is used, in the application step, for marking the electronic component. After marking, the liquid body is cured to a solid state through irradiation by light in the irradiation step and by heating in the heating step. In this instance, the liquid body containing 5 wt % or more of N-vinyl caprolactam is brought to a preferred cure state in the irradiation step by irradiation with light at a cumulative light dose equal to or greater than 200 mJ/cm². Then, the liquid body, which is already in a cure state, is heated in the heating step. The liquid body thereby reaches a more uniform and stable cure state. Thus, with regards to marking an electronic component, a liquid body containing 5 wt % or more of N-vinyl caprolactam is used, and a heating step is followed in addition to an application step and an irradiation step. It is thereby possible to obtain excellent characteristics with regards to adhesion performance with respect to the electronic component, as well as with regards to abrasion resistance and alcohol resistance as a marking.

A method for manufacturing an electronic component according to another aspect of the present invention includes: applying a liquid body onto an electronic component to perform marking, the liquid body having a light-curing property and containing 5 wt % or more of N-vinyl caprolactam; curing the liquid body applied onto the electronic component to a curing ratio equal to or greater than 95% by irradiating light on the liquid body; and heating the liquid body after the curing of the liquid body.

According to this method for manufacturing an electronic component, a liquid body containing 5 wt % or more of N-vinyl caprolactam is used for marking the electronic component. This liquid body is used, in the application step, for marking the electronic component; and cured, after marking, to a preferred state by the curing treatment step and by heating in the heating step. In this instance, the liquid body is irradiated with UV or another light in the curing treatment step so as to reach a cure state corresponding to a curing ratio equal to or greater than 95%. Then, the liquid body, which is already in a cure state, is heated in the heating step. The liquid body thereby reaches a more uniform and stable cure state. In the curing treatment step, the curing ratio of the light-curing liquid body can be obtained by a method such as using Fourier transform infrared spectroscopy (FTIR) to monitor the decrease in unsaturated bonds due to the curing reaction. The curing treatment step is set up on the basis of light irradiation conditions at which a curing ration equal to or greater than 95% is obtained, observed using a method of such description. Thus, with regards to marking an electronic component, a liquid body containing 5 wt % or more of N-vinyl caprolactam is used, and a heating step is followed in addition to an application step and a curing treatment step. It is thereby possible to obtain excellent characteristics with regards to adhesion performance with respect to the electronic component, as well as with regards to abrasion resistance and alcohol resistance as a marking.

In the method for manufacturing an electronic component according to each of the above-mentioned aspects, the heating of the liquid body preferably includes heating the liquid body at a temperature of 150 to 200° C.

According to this method, the heating temperature in the heating step is set to 150 to 200° C. Setting the heating temperature to this temperature range makes it possible to cause the liquid body, which has already reached a cure state in the irradiation step (curing treatment step), to reach a more uniform and stable cure state; avoid the effect of heat on the electronic component; and maintain the performance of the electronic component in a more reliable manner.

In the method of manufacturing an electronic component according to each of the above-mentioned aspects, the liquid body preferably contains N-vinyl caprolactam at a range of 5 to 20 wt %.

According to this method, the N-vinyl caprolactam contained in the liquid body is set to 5 to 20 wt %, and problems such as a fluctuation in the cure state in the irradiation step (curing treatment step) and the heating step are minimized. If the liquid body contains 5 wt % or more of N-vinyl caprolactam, a preferred cure state is reached. However, if the content exceeds 20 wt %, there are tendencies of, e.g., the quality stability decreasing and the viscosity increasing during storage. Compared to an instance in which the content is 20 wt % or less, the ink is moderately inferior in terms of, e.g., workability during the application step. Therefore, a setup in which the liquid body contains N-vinyl caprolactam so as to avoid this range in which the characteristics are even moderately inferior, i.e., in a range of 5 to 20 wt %, makes it possible for a stable and fluctuation-free cure state.

The method of manufacturing an electronic component according to each of the above-mentioned aspects preferably further includes performing a surface treatment of the electronic component by activating a surface of the electronic component before the applying of the liquid body onto the electronic component.

According to this method, the method further has a surface treatment step, whereby the surface of the electronic component is activated, and is in a state in which adhesion performance with respect to the liquid body is improved. By sending the electronic component in this state to the application step, it is possible to further improve the adhesion performance of the liquid body with respect to the electronic component.

A marking method according to another aspect of the present invention includes: applying a liquid body onto a member to be processed to perform marking, the liquid body having a light-curing property and containing 5 wt % or more of N-vinyl caprolactam; irradiating light on the liquid body applied to the member to be processed at a cumulative light dose equal to or greater than 200 mJ/cm²; and heating the liquid body after the irradiating of the light.

According to this marking method, a liquid body containing 5 wt % or more of N-vinyl caprolactam is used for marking of the member to be processed. This liquid body is used, in the application step, for marking a member to be processed in which the adhesion performance with respect to the liquid body has preferably been improved through surface treatment or a similar process. The liquid body is cured to a solid state through irradiation by light in the irradiation step and heating in the heating step. In this instance, the liquid body containing 5 wt % or more of N-vinyl caprolactam is brought to a preferred cure state in the irradiation step by irradiation with light at a cumulative light dose equal to or greater than 200 mJ/cm². Then, the liquid body, which is already in a cure state, is heated in the heating step. The liquid body thereby reaches a more uniform and stable cure state. Thus, with regards to marking a member to be processed, a liquid body containing 5 wt % or more of N-vinyl caprolactam is used, and a heating step is followed in addition to an application step and an irradiation step. It is thereby possible to obtain excellent characteristics with regards to adhesion performance with respect to the electronic component, as well as with regards to abrasion resistance and alcohol resistance as a marking.

A marking method according to another aspect of the present invention includes: applying a liquid body onto a member to be processed to perform marking, the liquid body having a light-curing property and containing 5 wt % or more of N-vinyl caprolactam; curing the liquid body applied to the member to be processed to a curing ratio equal to or greater than 95% by irradiating light on the liquid body; and heating the liquid body after the curing of the liquid body.

According to this marking method, a liquid body containing 5 wt % or more of N-vinyl caprolactam is used for marking the electronic component. This liquid body is used, in the application step, for marking a member to be processed in which the adhesion performance with respect to the liquid body has preferably been improved through surface treatment or a similar process. After marking, the liquid body is cured to a preferred solid state by the curing treatment step and heating in the heating step. In this instance, the liquid body containing 5 wt % or more of N-vinyl caprolactam reaches a cure state corresponding to a curing ratio equal to or greater than 95% in the curing treatment step. Then, the liquid body, which is already in a cure state, is heated in the heating step. The liquid body thereby reaches a more uniform and stable cure state. In the curing treatment step, the curing ratio of the light-curing liquid body can be obtained by a method such as using a Fourier transform infrared spectroscopy (FT-IR) to monitor the decrease in unsaturated bonds due to the curing reaction. The curing treatment step is set up on the basis of light irradiation conditions at which a curing ration equal to or greater than 95% is obtained, observed using a method of such description. Thus, with regards to marking an electronic component, a liquid body containing 5 wt % or more of N-vinyl caprolactam is used, and a heating step is followed in addition to an application step and a curing treatment step. It is thereby possible to obtain excellent characteristics with regards to adhesion performance with respect to the electronic component, as well as with regards to abrasion resistance and alcohol resistance as a marking.

A marking device according to another aspect of the present invention includes an ejecting part and an irradiation part. The ejecting part is configured and arranged to eject, onto a member to be processed, a liquid body having a light-curing property and containing 5 wt % or more of N-vinyl caprolactam. The irradiation part is configured and arranged to irradiate light on the liquid body ejected onto the member to be processed at a cumulative light dose equal to or greater than 200 mJ/cm².

According to this marking device, a liquid body containing 5 wt % or more of N-vinyl caprolactam is used for marking the electronic component. This liquid body is ejected using the ejecting part onto the member to be processed, and marking is performed. The liquid body used for marking is cured to a solid state through irradiation by light by the irradiation part. In this instance, the liquid body containing 5 wt % or more of N-vinyl caprolactam is brought to a preferred cure state through irradiation with light by the irradiation part at a cumulative light dose equal to or greater than 200 mJ/cm². Thus, with regards to marking using the marking device, a liquid body containing 5 wt % or more of N-vinyl caprolactam is used, whereby it is possible to obtain adhesion performance with respect to the member to be processed, as well as abrasion resistance and alcohol resistance as a marking.

A marking device according to another aspect of the present invention includes an ejecting part and a curing treatment part. The ejecting part is configured and arranged to eject, onto a member to be processed, a liquid body having a light-curing property and containing 5 wt % or more of N-vinyl caprolactam. The curing treatment part is configured and arranged to irradiate light on the liquid body applied to the member to be processed to perform curing of the liquid body to a curing ratio equal to or greater than 95%.

According to this marking device, a liquid body containing 5 wt % or more of N-vinyl caprolactam is used for marking the electronic component. This liquid body is ejected using the ejecting part onto the member to be processed, and marking is performed. The liquid body used for marking is cured to a solid state through irradiation by light by the curing treatment part. Thus, with regards to marking using the marking device, a liquid body containing 5 wt % or more of N-vinyl caprolactam is used, and curing is performed to a curing ratio equal to or greater than 95%, whereby it is possible to obtain adhesion performance with respect to the member to be processed, as well as abrasion resistance and alcohol resistance as a marking.

The marking device according to each of the above described aspects preferably further includes a heating part configured and arranged to heat the liquid body after the liquid body is cured.

According to this configuration, the marking device further includes a heating part for applying heating after the irradiation of light by the irradiation part. The liquid body is thereby heated by the heating part in addition to being cured through irradiation by light by the irradiation part, and reaches a more uniform and stable cure state.

Also, according to this configuration, the marking device further comprises a heating part for applying heating after the liquid body has been cured by irradiation of light in the curing treatment step to a curing ratio equal to or greater than 95%. Accordingly, the liquid body is heated by the heating part in addition to being cured by the curing treatment part, and thereby reaches a more uniform and stable cure state.

Using this marking device makes it possible to perform a step for heating in a continuous manner and to improve working efficiency.

### BRIEF DESCRIPTION OF THE DRAWINGS

Referring now to the attached drawings which form a part of this original disclosure:

FIG. 1 is a top view showing markings on an electronic component;

FIG. 2 is a perspective schematic view showing the configuration of a marking device;

FIG. 3A shows a schematic view of a carriage and a work, and FIG. 3B shows a plan view of a nozzle arrangement on a nozzle unit;

FIG. 4 is a flow chart showing a marking procedure; and

FIG. 5A shows a graph of the absorbance of ink and FIG. 5B shows a graph of the curing ratio of ink.

### DETAILED DESCRIPTION OF EXEMPLARY EMBODIMENTS

The method for manufacturing, the method for marking, and the device for marking an electronic component according to the present invention will now be described with reference to the accompanying drawings. Here, a description will be given for an example of a method in which a marking device that uses the inkjet method is used to apply marking on a semiconductor chip, which is an electronic component.

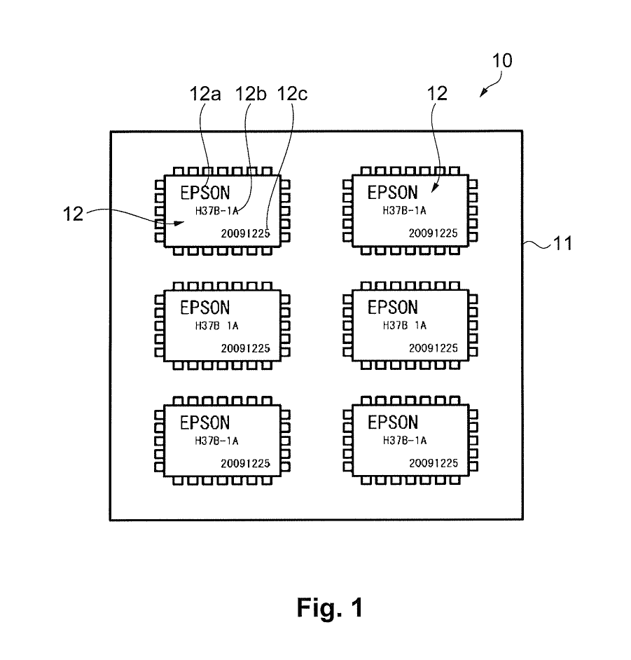

FIG. 1 is a top view showing markings on an electronic component. As shown in FIG. 1, a work 10, which is a member to be processed, has a placement platform 11 and semiconductor chips 12, which are electronic components placed on the placement platform 11. Markings, such as a logo 12a, a product code 12b, and a serial number 12c are present on a surface of the semiconductor chips 12. In such an instance, in the semiconductor chips 12, an integrated circuit (IC) or a similar structure is packaged by an epoxy resin, and markings are drawn on a surface section of the epoxy resin using ink (a liquid body).

A non-absorbent material is preferably used for the package material in order to prevent ink from penetrating into the interior of the semiconductor chips 12. Other than epoxy resin, examples include silicon, a phenol resin, polyimide, polymethyl methacrylate, silicon nitride or another nitride, or a boride. From amongst the materials listed above, an epoxy resin or silicon is preferred due to an excellent adhesion performance with regards to ink.

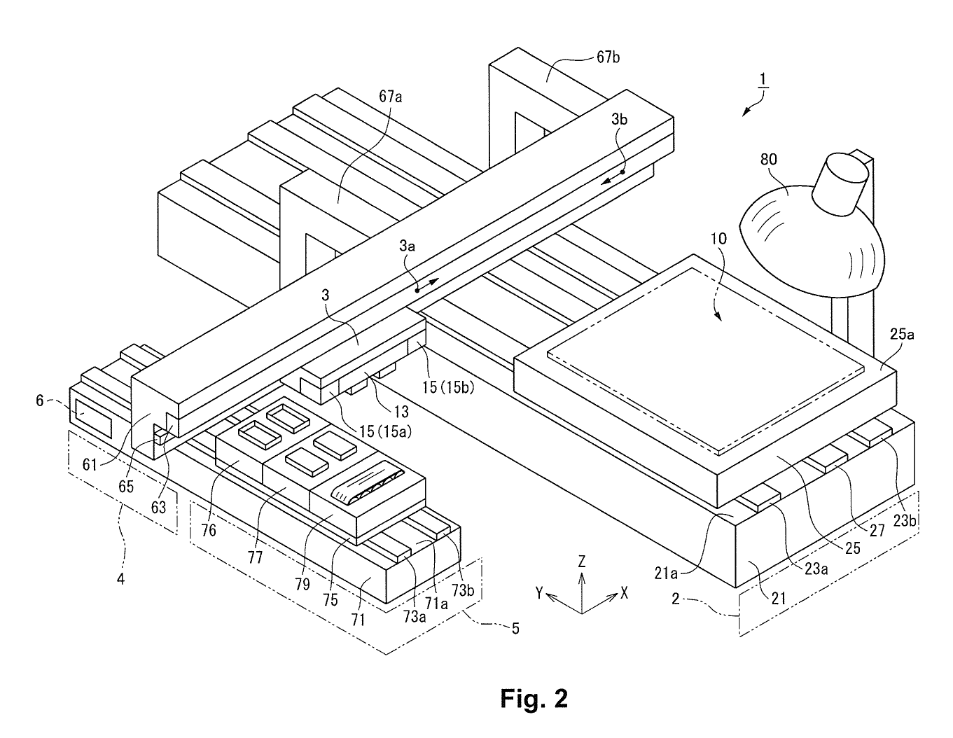

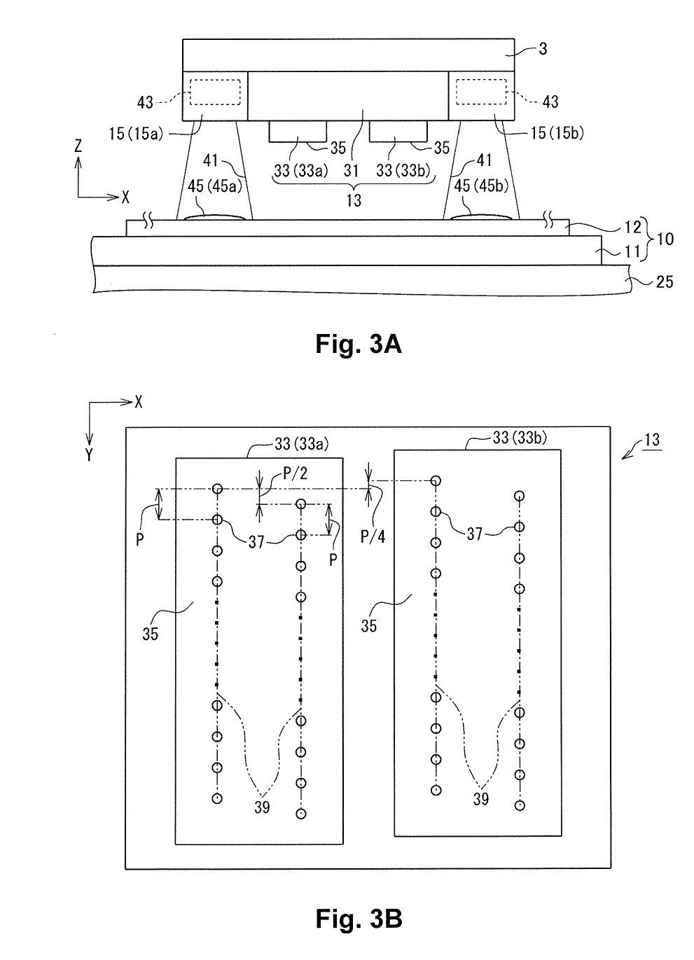

Next, a description will be given for a marking device for marking the semiconductor chips 12 with ink. FIG. 2 is a perspective schematic view showing the configuration of the marking device. FIG. 3A is a top view showing a carriage and a work, and FIG. 3B is a top view showing a nozzle arrangement on a nozzle unit.

First, as shown in FIG. 2, the marking device 1 is a device that uses the inkjet method, and has a work-transporting device 2 for transporting the work 10, a carriage 3, a carriage-transporting device 4, and a maintenance device 5. The carriage 3 is provided with a head unit (ejecting part) 13, and two irradiation devices (curing treatment part) 15. In the marking device 1, ink is ejected as liquid droplets from the head unit 13 while the relative position between the head unit 13 and the work 10 in plan view is varied. It is thereby possible for a marking to be applied using ink according to a desired pattern. In the drawing, the y-direction represents a direction of movement of the work 10 and the x-direction represents a direction that is perpendicular to the y-direction in plan view. A direction that is perpendicular to an x-y plane defined by the x-direction and the y-direction is defined as the z-direction.

In the marking device 1, the work-transporting device 2 has a platen 21; guide rails 23a, 23b; a work table 25; and a table-position-detecting device 27. The platen 21 is configured from, e.g., stone or another material having a small thermal expansion coefficient, and is disposed so as to extend, along with the guide rails 23a, 23b, along the y-direction. The work table 25 is provided in a state of being opposite an upper surface 21a of the platen 21 interposed by the guide rails 23a, 23b, and has a surface 25a on which the work 10 is placed. The table-position-detecting device 27 is provided on the upper surface 21a of the platen 21, and is used for detecting the position of the work table 25 in the y-direction. The work table 25 is configured so as to be capable of being moved in a reciprocating manner along the y-direction by a movement mechanism and a power source (not shown). Examples of the movement mechanism include a mechanism in which a ball screw and a ball nut are combined, or a linear guide mechanism. In the marking device 1, a linear guide mechanism is used.

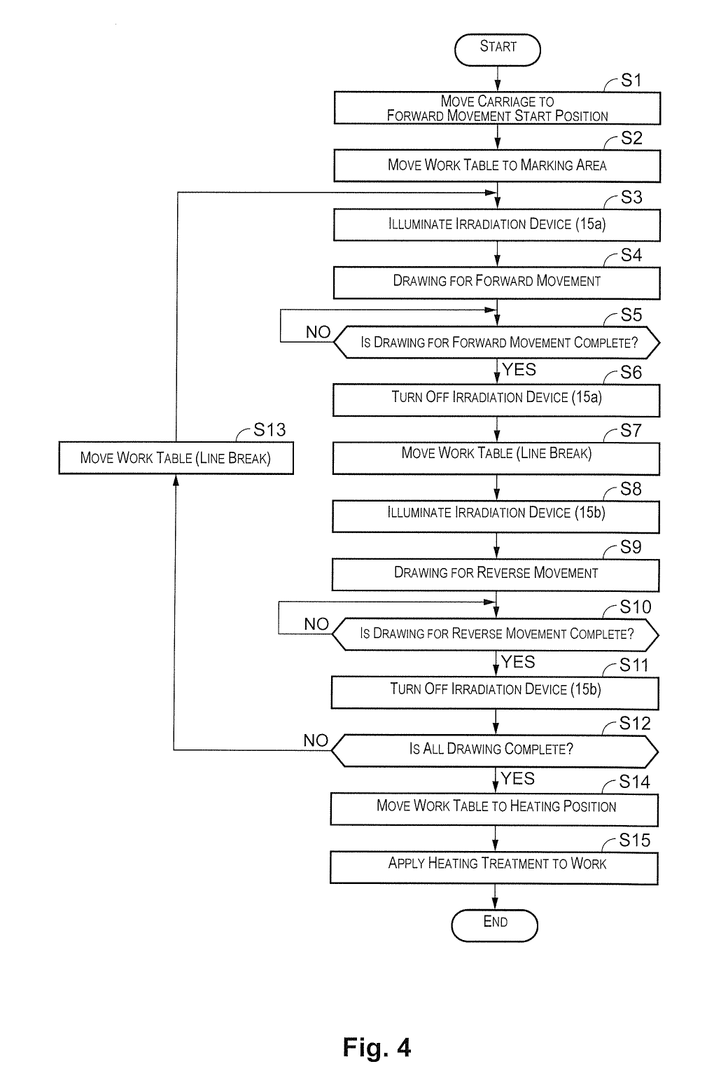

The carriage-transporting device 4 has a frame 61, a guide rail 63, and a carriage-position detecting device 65; and is supported by a support column 67a and a support column 67b. The frame 61 extends along the x-direction, and straddles the work-transporting device 2 and the maintenance device 5 in the x-direction. The guide rail 63 is provided on a side of the frame 61 nearer the platen 21, and supports the carriage 3 in a state in which reciprocal movement is possible in the x-direction. The carriage 3 is configured so as to be capable of being moved in a reciprocating manner along the x-direction by a movement mechanism and a power source (not shown). As with the work table 25, a linear guide mechanism is used as the movement mechanism. The carriage-position detecting device 65 is provided so as to extend in the x-direction between the frame 61 and the guide rail 63, and used for detecting the position of the carriage 3 in the x-direction. The carriage-transporting device 4 has a forward movement start position 3a and a reverse movement start position 3b. The forward movement start position 3a is a start position for a forward movement when the carriage 3 is moved in a reciprocating manner, and the reverse movement start position 3b is a start position for a reverse movement of the carriage 3. In the work-transporting device 2, a side on one direction along the y-direction relative to the carriage-transporting device 4 is a placement position described further below with reference to FIG. 4, and a side on the other direction is a heating position. FIG. 2 shows a state in which the work table 25 is at the heating position.

The maintenance device 5 has a platen 71; guide rails 73a, 73b; a maintenance table 75; a capping unit 76; a flushing unit 77; and a wiping unit 79. The platen 71 is configured from, e.g., stone or another material having a small thermal expansion coefficient, and is provided at a position facing the platen 21 interposed by the support column 67a in the x-direction. The maintenance table 75 is provided in a state of opposing an upper surface 71a of the platen 71 interposed by the guide rails 73a, 73b. Maintenance units such as the capping unit 76, the flushing unit 77, and the wiping unit 79 are placed on the maintenance table 75. The maintenance table 75 is guided along the y-direction by the guide rails 73a, 73b, and is configured so as to be capable of moving in a reciprocating manner along the y-direction on the platen 71.

The capping unit 76 is a device for putting a cap on the head unit 13. Ink ejected from the head unit 13 may increase in viscosity due to evaporation of a liquid component, and decrease in performance in terms of being ejected as liquid droplets. An operation in which a cap is put on the head unit 13 in order to prevent this is referred to as capping.

The flushing unit 77 is a device for receiving the ink ejected from the head unit 13 during a flushing operation. A flushing operation refers to an operation in which ink is ejected from the head unit 13 for a purpose unrelated to drawing a marking on the work 10, and has effects such as preventing a situation in which ink retained in the head unit 13 solidifies and ejection becomes difficult.

The wiping unit 79 is a device for sweeping the head unit 13. Ink may adhere to the head unit 13, and cause a decrease in performance in terms of ejecting ink as liquid droplets. The wiping unit 79 sweeps the head unit 13, and can thereby sweep away the ink causing this performance decrease and maintain ejecting performance. An operation of sweeping the head unit 13 with the wiping unit 79 is referred to as wiping.

The maintenance table 75 is configured so as to be capable of being moved in a reciprocating manner along the y-direction by a linear guide mechanism (not shown). The maintenance device 5 is thereby capable of moving the capping unit 76, the flushing unit 77, and the wiping unit 79 in a reciprocating manner along the y-direction, and is capable of causing the head unit 13 to be opposite to each of the capping unit 76, the flushing unit 77, and the wiping unit 79 in a state in which the head unit 13 is overlapping with the maintenance device 5 in plan view.

As shown in FIGS. 3A and 3B, the carriage 3 has a head plate 31 and two ejection heads 33a, 33b provided to the head plate 31. The two ejection heads 33 are arranged in a row along the x-direction. Each of the ejection heads 33 has a nozzle surface 35 on which a plurality of nozzles 37 are formed. The nozzle surface 35 faces towards the work table 25, i.e., towards the work 10, in the z-direction. In each of the ejection heads 33, the nozzles 37 form two nozzle columns 39 arranged along the y-direction. The two nozzle columns 39 are arranged next to each other so that a spacing is present therebetween in the x-direction. In each of the nozzle columns 39, the nozzles 37 are formed along the y-direction at predetermined nozzle intervals P. The two nozzle columns 39 are displaced relative to each other by a distance P/2 in the y-direction. In the head unit 13, the nozzle column 39 on one of the two ejection heads 33 and the nozzle column 39 on the other ejection head 33 are displaced relative to each other by distance P/4 in the y-direction. Therefore, the density of the nozzles 37 in the y-direction is higher.

Two irradiation devices 15a, 15b are provided at positions that face each other in the x-direction interposed by the head unit 13. The irradiation device 15a is positioned on a side of the ejection head 33a opposite a side nearer the ejection head 33b with respect to the x-direction. The irradiation device 15b is positioned on a side of the ejection head 33b opposite a side nearer the ejection head 33a with respect to the x-direction. In the marking device 1, each of the irradiation devices 15a, 15b has a light source 43 for generating UV light 41. The UV light 41 from the light source 43 is capable of promoting curing of the ink 45, which is a liquid body ejected from the ejection heads 33. In other words, the ink 45 has a light-curing property. Light in this instance is the UV light 41, as an example of light. Using the UV light 41 makes it possible to cause the ink 45 to cure almost instantaneously, and also to minimize the effect of heat on the semiconductor chips 12. A UV-emitting diode (UV-LED) is used as the light source 43 of the irradiation devices 15. However, a UV laser diode (UV-LD), a mercury lamp, a metal halide lamp, a xenon lamp, an excimer lamp, or another light source may also be used. The curing of the ink 45 will be described in detail further below with reference to FIG. 4.

The marking device 1 has a control part 6 for controlling the operation of each of the above-mentioned structures. The control part 6 has a central processing unit (CPU), a drive control part, a memory part, and other components (not shown). The CPU performs, as a processor, a variety of computation processes, and the drive control part controls the driving of each of the structures. The memory part includes a random-access memory (RAM), a read-only memory (ROM), and similar elements. The memory part is provided with a region for storing program software containing procedures for controlling operations performed in the marking device 1, a data expansion region for temporarily expanding a variety of data, and other regions. Examples of data in the data expansion region include marking data indicating a marking pattern to be drawn on the semiconductor chips 12 and program data for drawing and other processes.

A description will now be given for the ink 45 used in the marking device 1. The ink 45 in the present embodiment is a UV-curing ink having a light-curing property, and is a liquid body containing 5 wt % or more of N-vinyl caprolactam. In the ink 45, the N-vinyl caprolactam has been selected as an ideal polymerizable compound for adding as an ink composition to improve the adhesion performance of the ink 45 with respect to the semiconductor chips 12, and the abrasion resistance and the alcohol resistance of the ink 45. The N-vinyl caprolactam, if contained in the ink 45 at 5 wt % or more, undergoes polymerization by being irradiated with light by the irradiation devices 15, and causes the ink 45 to reach a preferred cure state, i.e., a cure state corresponding to a curing ratio equal to or greater than 95%. However, if the content is in excess of 20 wt %, there are tendencies of, e.g., the quality stability decreasing and the viscosity increasing during storage of the ink 45. Compared to an instance in which the content is 20 wt % or less, the ink is inferior, although by a moderate extent, in terms of, e.g., workability during marking or other tasks. Therefore, having the ink 45 contain 5 wt % or more of N-vinyl caprolactam will be effective. It is further preferable that the content is within a range of 5 to 20 wt %.

Examples of a polymerizable compound contained as a composition in common ink include a compound having, in a molecule, both a vinyl group and a (meth)acryl group. Specific examples include: 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 4-vinyloxycyclohexyl (meth)acrylate, 5-vinyloxypentyl (meth)acrylate, 6-vinyloxyhexyl (meth)acrylate, 4-vinyloxymethylcyclohexyl methyl (meth)acrylate, p-vinyloxymethylphenylmethyl (meth)acrylate, 2-(vinyloxyethoxy)ethyl (meth)acrylate, 2-(vinyloxyethoxyethoxy)ethyl (meth)acrylate, and 2-(vinyloxyethoxyethoxyethoxy)ethyl (meth)acrylate. With the foregoing in view, the ink 45 has a composition containing 2-(vinyloxyethoxy)ethyl acrylate (VEEA) or a similar substance having a low viscosity, a high flash point, and excellent reactivity and adhesion performance, and further containing N-vinyl caprolactam as a required polymerisable compound in order to further improve adhesion performance, abrasion resistance, alcohol resistance, and other characteristics.

The ink 45 includes a color material as a composition, and can be used for marking using white, black, yellow, magenta, and cyan colors. At least one of a pigment or a dye can be used as the color material. Either an inorganic pigment or an organic pigment can be used as the pigment. Examples of an inorganic pigment include furnace black, lamp black, acetylene black, channel black, or another carbon black; iron oxide; and titanium oxide. Examples of an organic pigment include an insoluble azo pigment, a condensed azo pigment, an azo lake, a chelate azo pigment, or another azo pigment; a phthalocyanine pigment, a perinone and perylene pigment, an anthraquinone pigment, a quinacridone pigment, a dioxane pigment, a thioindigo pigment, an isoindolinone pigment, a quinophthalone pigment, or another polycyclic pigment; a chelate dye (e.g., a basic dye-type chelate, an acidic dye-type chelate), a lake pigment (e.g., a basic dye-type lake, acidic dye-type lake); a nitro pigment; a nitroso pigment; anyline black; and a daytime fluorescent pigment. In the instance of the ink 45, since marking is applied to a dark-colored surface of the semiconductor chips 12, a white pigment is used as the color material.

Next, a description will be given for a treating method for the marking performed in the marking device 1. FIG. 4 is a flow chart showing a marking procedure. In the marking device 1, drawing is started on the basis of marking data by a command from the control part 6. Therefore, the flow chart shows a procedure executed by the control part 6.

In this example, a surface treatment step is performed before the drawing performed according to the flow chart by the marking device 1. In the surface treatment step, the semiconductor chips 12 on the work 10 are irradiated using a low-pressure mercury lamp. In such an instance, the treatment conditions in the surface treatment step are as follows. The work 10 is irradiated with light at an intensity of 0.01 to 60 mW/cm² for a duration of between 5 to 10 seconds from a low-pressure mercury lamp having strong line spectra at 185 nm and 254 nm under an atmosphere containing oxygen, i.e., under a treatment atmosphere having an oxygen concentration of 20 to 100 volume percent and a temperature of 160 to 190° C. Under these conditions, it is possible to avoid oxidation, damage, and the like extending from the surface to the deep interior of the semiconductor chips 12, even for semiconductor chips 12 that have been packaged using an epoxy resin. Semiconductor chips 12 subjected to surface treatment of such description have been improved so as to have an activated surface and have good adhesion performance with respect to the ink 45. The surface treatment step is not performed in the marking device 1 in this instance. However, a configuration is also possible in which the marking device 1 comprises an activating part that is capable of, e.g., applying heating under an atmosphere for performing the surface treatment, whereby the surface treatment step is performed through a control performed by the control part 6. The work 10, having been subjected to surface treatment applied on the semiconductor chips 12, is placed on the work table 25 at the placement position.

With regards to marking performed by the marking device 1, first, the carriage 3 is moved to the forward movement start position 3a, in step S1 in the flow chart. The forward movement start position 3a is a start position for the forward movement when the carriage 3 is moved in a reciprocating manner. The forward movement start position 3a is positioned between the maintenance device 5 and the work table 25 in the x-direction, and outside the work table 25 in plan view. The work 10, having been subjected to the treatment in the surface treatment step, is positioned on the work table 25. After the carriage 3 has been moved, the flow proceeds to step S2.

In step S2, the work table 25 is moved to a marking area. The marking area is a region at which there is an overlap between a trajectory along which the ejection heads 33 move along the x-direction between the forward movement start position 3a and the reverse movement start position 3b and a trajectory along which the work table 25 moves along the y-direction; and is an area within which marking is performed on the semiconductor chips 12. After the work table 25 has been moved, the flow proceeds to step S3, and then to step S4.

In step S3, the irradiation device 15a is illuminated, and in step S4, drawing for the forward movement is performed. Drawing for the forward movement is performed by controlling the driving of the ejection heads 33 and causing the ink 45 to be ejected from each of the nozzles 37 on the basis of the marking data in a state in which the irradiation device 15a is illuminated. Markings, such as the logo 12a, the product code 12b, and the serial number 12c (FIG. 1) are drawn on the surface of the semiconductor chips 12. At this time, the irradiation device 15a causes the ink 45 ejected onto the surface of the semiconductor chips 12 to be cured by the UV light 41 to a curing ratio equal to or greater than 95%. The light source 43 of the irradiation device 15a is a UV-emitting diode (UV-LED) mentioned further above. In this instance, the light source 43 has a peak wavelength of 365 nm, and is configured so as to emit a UV light 41 at a cumulative light dose equal to or greater than 200 mJ/cm² onto the ink 45 ejected onto the semiconductor chips 12. The ink 45 is thereby cured on the surface of the semiconductor chips 12 in a state of having good adhesion performance. The step S4 corresponds to an application step. When drawing for the forward movement has been performed, the flow proceeds to step S5.

In step S5, it is determined whether or not the drawing for the forward movement is complete. This determining is performed by the CPU of the control part 6. If the drawing is complete, the flow proceeds to step S6. If the drawing is not complete, the flow continues to loop in step S5 until the drawing is complete.

If the drawing is complete, the irradiation device 15a is turned off in step S6. Steps S3 through S6 correspond to an irradiation step (curing treatment step). In other words, step S4 corresponds to both the application step and the irradiation step (curing treatment step).

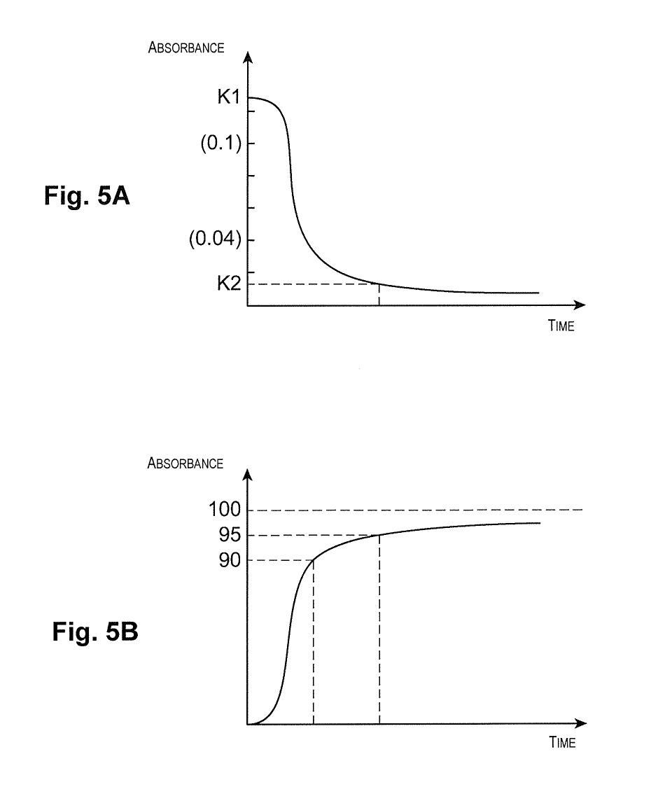

A brief description will now be given for a method for observing that the ink 45 has cured to a curing ratio equal to or greater than 95%. FIG. 5A show a graph of the absorbance of ink and FIG. 5B shows a graph of the curing ratio of ink. In this method, Fourier transform infrared spectroscopy (FT-IR) is used to monitor the decrease in unsaturated bonds (C═C) due to the curing reaction in the ink 45 and to obtain the absorbance, and the curing ratio is calculated from the absorbance. In the instance of the ink 45, with regards to the monitoring, the decrease in unsaturated bonds (C═C) during the curing reaction, i.e., in the example of the ink 45, a decrease in the peak intensity at a wavenumber of 810 cm⁻¹, is monitored and obtained as absorbance shown in FIG. 5A. According to FIG. 5A, the absorbance decreases with curing of the ink 45 with the passage of time. The curing ratio of the ink 45 shown in FIG. 5B increases, in a substantially inversely proportional manner to the decrease in the absorbance. With regards to the curing ratio, it is assumed that the absorbance in a state before the start of the curing reaction (K1 in FIG. 5A) corresponds to a curing ratio of 0 (zero) %, and the state in which the absorbance is 0 (zero) corresponds to a curing ratio of 100%. It is thereby possible to obtain a curing ratio of the ink 45, as a curing ratio of 95%, in a state at a point in time (time) corresponding to an absorbance K2 at which the absorbance has decreased by, e.g., 95%.

In a UV-curing resin such as the ink 45, the amount of fluorescent light generated tends to increase as the curing reaction progresses, and the curing ratio can also be obtained using this characteristic. Specifically, it is possible to compare the amount of fluorescent light generated from the ink 45 with a predetermined threshold value to determine the curing ratio of the ink 45. After the irradiation device 15a has been turned off, the flow proceeds to step S7.

In step S7, the work table 25 is moved. In step S7, the control part 6 issues a command and causes the work table 25 to be moved, and thereby performs a so-called line break so that new marking can be applied onto the semiconductor chips 12. After the line break, the flow proceeds to step S8, and then to step S9.

In step S8, the irradiation device 15b is illuminated, and in step S9, drawing for the reverse movement is performed. Drawing for the reverse movement is performed by controlling the driving of the ejection heads 33 and causing the ink 45 to be ejected from each of the nozzles 37 on the basis of the marking data in a state in which the irradiation device 15b is illuminated. At this time, as with the irradiation device 15a, the irradiation device 15b causes the ink 45 ejected onto the surface of the semiconductor chips 12 to be cured by the UV light 41 to a curing ratio equal to or greater than 95%. The step S9 corresponds to the application step. When drawing for the reverse movement has been performed, the flow proceeds to step S10.

In step S10, it is determined whether or not the drawing for the reverse movement is complete. This determining is performed by the CPU of the control part 6. If the drawing is complete, the flow proceeds to step S 11. If the drawing is not complete, the flow continues to loop in step S10 until the drawing is complete.

If the drawing is complete, the irradiation device 15b is turned off in step S11. Steps S8 through S11 correspond to the irradiation step (curing treatment step). After the irradiation device 15b has been turned off, the flow proceeds to step S12.

In step S12, it is determined whether all drawing is complete. This determining is performed by the CPU of the control part 6. If a part of the drawing is not yet complete, the flow proceeds to step S13. If all drawing is complete, the flow proceeds to step S14.

If the drawing is not yet complete, the work table 25 is moved in step S13. In step S13, the control part 6 issues a command and causes the work table 25 to be moved, and thereby performs a so-called line break so that new marking can be applied onto the semiconductor chips 12. After the line break, the flow proceeds to step S3, and drawing is continued.

Meanwhile, if all drawing is complete, the work table 25 is moved to the heating position in step S14. The heating position is a position at which the semiconductor chips 12 on which marking has been performed can be heated using a hotplate (heating part; not shown). In this step, in the marking device 1, the work table 25 is in a state of having moved along the y-direction from the marking area to the heating position. After the work table 25 has been moved, the flow proceeds to step S15.

In step S15, the work 10 is subjected to a heating treatment. Specifically, the semiconductor chips 12 is heated, whereby the markings drawn onto the semiconductor chips 12 using the ink 45 and cured by the irradiation devices 15 are placed in an even more satisfactory cure state. This heating is a configuration in which the semiconductor chips 12 on which markings have been drawn are arranged on a hotplate and heated at a temperature of 180° C., which is within the range of 150 to 200° C. A heating temperature of 180° C. makes it possible to avoid, e.g., the effect of heat on the semiconductor chips 12 and maintain the performance of the semiconductor chips 12 intact. The step S15 corresponds to a heating step. When the heating treatment is complete, the flow is complete.

### First Embodiment

Next, a description will be given for evaluation results for instances in which, in relation to marking in which a variety of types of ink including the ink 45 are used, the ink composition and UV irradiation conditions are varied. Table 1 shows results of a comparative evaluation of an instance in which 5 types of ink, each containing compositions at 5 different proportions, are irradiated with the UV light 41 at a cumulative light dose equal to or greater than 200 mJ/cm² (UV only), and an instance in which the 5 types of ink are irradiated with the UV light 41 at a cumulative light dose equal to or greater than 200 mJ/cm² and heated at 180° C. (UV+heating), in the irradiation step (steps S3 through S6 and S8 through S11) shown in FIG. 4. The comparative evaluation indicates the adhesion performance, abrasion resistance, and alcohol resistance of the ink.

TABLE 1

| | | | | | | Comparative |
|---|---|---|---|---|---|---|
| | | Test example 1-1 | Test example 2-1 | Test example 3-1 | Test example 4-1 | example 1-1 |
| Main | NVC | 5.0 | 100.0 | 15.0 | 20.0 | 3.0 |
| composi- | VEEA | 50.0 | 40.0 | 20.0 | 30.0 | 33.0 |
| tion of test | PET3A | 11.6 | 5.0 | 18.0 | 10.0 | 5.0 |
| ink (wt %) | PEA | 2.0 | 13.6 | 15.6 | 3.6 | 27.6 |

| | | | | | | | | | | |
|---|---|---|---|---|---|---|---|---|---|---|
| Ink curing | UV | UV + | UV | UV + | UV | UV + | UV | UV + | UV | UV + |
| | only | heating | only | heating | only | heating | only | heating | only | heating |
| Adhesive property | C | B | C | B | B | A | B | B | D | C |
| Abrasion resistance | C | B | B | A | C | A | B | A | C | C |
| Alcohol resistance | C | B | B | B | B | A | C | B | D | D |

As shown in Table 1, five types of test ink, for test examples 1-1 through 4-1 and a comparative example 1-1, were prepared and evaluated. The N-vinyl caprolactam (NVC), which is a required polymerisable compound in the present embodiment, is contained at 5 wt % in the ink used in the test example 1-1, at 10 wt % in the ink used in the test example 2-1, at 15 wt % in the ink used in the test example 3-1, at 20 wt % in the ink used in the test example 4-1, and at 3 wt % in the ink used in the comparative example 1-1. Some of the other compositions, such as 2-(vinyloxyethoxy)ethyl acrylate (VEEA), are also shown as reference. The method for curing the inks were divided into the method involving UV only and the method involving UV+heating, and a comparative evaluation was performed on each of the methods.

A description will now be given for results of the comparative evaluation in relation to the adhesion performance. The adhesion performance was evaluated so as to conform to JIS K-5600-5-6 (ISO2409) (Testing Methods for Paints—Part 5: Mechanical Property of Film—Section 6: Adhesion Test (Cross-Cut Test)). The performance of adhesion between the surface of a semiconductor chip 12 and a marking drawn on the surface was evaluated. According to the cross cut test, first, a single-bladed cutting tool, as a cutting tool (a common commercially available cutter) and a guide for guiding the single-bladed cutting tool so that incisions can be made at equal intervals, were readied. The blade of the cutting tool was applied so as to be orthogonal to the film of the marking, and six incisions were made. After the six incisions have been made, the orientation was changed by 90°, and six more incisions were made so as to be perpendicular to the incisions already made. Next, a transparent adhesive tape (width 25±1 mm) was prepared so as to have a length of approximately 75 mm, the tape was pasted on the portion of the film that has been cut in a grid pattern, and the tape was rubbed well using a finger so that the film becomes visible through the tape. Next, within 5 minutes of the tape being pasted, the tape was completely peeled over 0.5 seconds to 1.0 second at an angle near 60° relative to the film.

Criteria for evaluation of the adhesion performance performed as described above are as follows. A and B represent evaluation criteria that can be tolerated for practical use.

A: No peeling in any grid cell.

B: Peeling observed in some grid cells.

C: Peeling observed in 50% or more grid cells.

D: Peeling observed throughout.

As can be seen in the evaluation results shown in Table 1, in test example 1-1, the adhesion performance is evaluated as C in the ink-curing method involving UV only, but improves to an evaluation of B in the ink-curing method involving UV+heating. Similarly, the adhesion performance evaluation improved from C to B in the test example 2-1, improved from B to A in the test example 3-1, remained from B to B in the test example 4-1, and improved from D to C in the comparative example 1-1. In other words, in each of the test examples and the comparative example, an improvement in adhesion performance was observed in the ink-curing method involving UV+heating in comparison to the ink-curing method involving UV only. However, for the comparative example 1-1, the results cannot be tolerated for practical use, even when an ink-curing method using UV+heating has been used.

Next, a description will be given for results of a comparative evaluation in relation to abrasion resistance. For the abrasion resistance, a variable-load friction-and-wear testing system (e.g., Tribogear TYPE-HHS2000 (commercial name); Shinto Scientific, Co., Ltd) was used to observe the degree of peeling of the marking film. As for the condition, the marking film was scratched using a sapphire needle measuring 0.2 mm in diameter using a constant load, and the degree of peeling of the film was observed.

Criteria for evaluation of the abrasion resistance performed as described above are as follows. A and B represent evaluation criteria that can be tolerated for practical use.

A: No damage or peeling of film.

B: Some damage on film, but no peeling observed.

C: Some damage on film, and peeling of film observed.

D: Damage on film throughout, and peeling of film observed.

As can be seen in the evaluation results shown in Table 1, in test example 1-1, the abrasion resistance is evaluated as C in the ink-curing method involving UV only, but improves to an evaluation of B in the ink-curing method involving UV+heating. Similarly, the abrasion resistance evaluation improved from B to A in the test example 2-1, improved significantly from C to A in the test example 3-1, improved from B to A in the test example 4-1, and remained from C to C in the comparative example 1-1. In other words, in each of the test examples and the comparative example, an improvement in the abrasion resistance was observed in the ink-curing method involving UV+heating in comparison to the ink-curing method involving UV only. However, for the comparative example 1-1, the results cannot be tolerated for practical use, as with the adhesion performance.

Next, a description will be given for results of a comparative evaluation in relation to alcohol resistance. For the alcohol resistance, a marking on a semiconductor chip 12 was immersed for one minute in an isopropyl alcohol solution and then removed from the solution, and the degree of peeling of the marking was observed using a similar condition as that according to the abrasion resistance evaluation already described.

Criteria for evaluation of the alcohol resistance performed as described above are as follows. A and B represent evaluation criteria that can be tolerated for practical use.

A: No damage or peeling of film.

B: Some damage on film, but no peeling observed.

C: Some damage on film, and peeling of film observed.

D: Damage on film throughout, and peeling of film observed.

As can be seen in the evaluation results shown in Table 1, in test example 1-1, the alcohol resistance is evaluated as C in the ink-curing method involving UV only, but improves to an evaluation of B in the ink-curing method involving UV+heating. The evaluation remained from B to B in the test example 2-1, improved from B to A in the test example 3-1, improved from C to B in the test example 4-1, and remained from D to D in the comparative example 1-1. In other words, in each of the test examples and the comparative example, an improvement in the alcohol resistance was observed in the ink-curing method involving UV+heating in comparison to the ink-curing method involving UV only. However, for the comparative example 1-1, the results cannot be tolerated for practical use, as with the adhesion performance and abrasion resistance.

The results for the comparative example 1-1 are results that cannot be tolerated in regards to adhesion performance, abrasion resistance, and alcohol resistance. It can be determined that this is caused by the content of the N-vinyl caprolactam (NVC) in the ink being 3 wt %. Accordingly, it can be said that the content of the N-vinyl caprolactam (NVC) in the ink is preferably equal to or greater than 5 wt %. The ink 45 used in the marking device 1 is the ink evaluated in the test example 3-1. The results show that the ink 45 used for marking the semiconductor chips 12 has, if treated using the ink-curing method involving UV+heating, an evaluation of A for all of adhesion performance, abrasion resistance, and alcohol resistance, and has excellent characteristics.

Next, a description will be given for evaluation results for instances in which, in relation to marking in which the ink 45 is used, a curing method in which the UV light irradiation condition is different is applied to five types of ink having compositions similar to those shown in Table 1. The curing method is different in that irradiation by UV light 41 is applied at a cumulative light dose of less than 200 mJ/cm² in the irradiation step (steps S3 through S6 and S8 through S11) shown in FIG. 4. A divergence with respect to an instance in which the irradiation by UV light 41 is applied at a cumulative light dose equal to or greater than 200 mJ/cm² is thereby identified. Table 2 shows results of a comparative evaluation of an instance in which the 5 types of ink are irradiated with the UV light 41 at a cumulative light dose of less than 200 mJ/cm² (UV only), and an instance in which the 5 types of ink are irradiated with the UV light 41 at a cumulative light dose of less than 200 mJ/cm² and heated at 180° C. (UV+heating). The comparative evaluation indicates the adhesion performance, abrasion resistance, and alcohol resistance of the ink. The ink used in each of test examples 5-1, 6-1, 7-1, and 8-1 and comparative example 2-1 in Table 2 are the same as that used in each of test examples 1-1,2-1, 3-1, and 4-1, and comparative example 1-1 in Table 1, respectively.

TABLE 2

| | | | | | | Comparative |
|---|---|---|---|---|---|---|
| | | Test example 5-1 | Test example 6-1 | Test example 7-1 | Test example 8-1 | example 2-1 |
| Main | NVC | 5.0 | 100.0 | 15.0 | 20.0 | 3.0 |
| composi- | VEEA | 50.0 | 40.0 | 20.0 | 30.0 | 33.0 |
| tion of test | PET3A | 11.6 | 5.0 | 18.0 | 10.0 | 5.0 |
| ink (wt %) | PEA | 2.0 | 13.6 | 15.6 | 3.6 | 27.6 |

| | | | | | | | | | | |
|---|---|---|---|---|---|---|---|---|---|---|
| Ink curing | UV | UV + | UV | UV + | UV | UV + | UV | UV + | UV | UV + |
| | only | heating | only | heating | only | heating | only | heating | only | heating |
| Adhesive property | D | C | D | C | C | B | C | C | D | D |
| Abrasion resistance | D | C | C | C | C | B | C | B | D | D |
| Alcohol resistance | D | D | D | C | C | B | C | C | D | D |

First, a description will be given for results of the comparative evaluation in relation to adhesion performance. The evaluation method and evaluation criteria are identical to those described with reference to Table 1; therefore, a description shall not be given, and only the results will be described. As can be seen from the evaluation results shown in Table 2, in the test example 5-1, the adhesion performance is evaluated as D in the ink-curing method involving UV only, but improves to an evaluation of C in the ink-curing method involving UV+heating. Similarly, the adhesion performance evaluation improved from D to C in the test example 6-1, improved from C to B in the test example 7-1, remained from C to C in the test example 8-1, and remained from D to D in the comparative example 2-1. In other words, in each of the test examples and the comparative example, a moderate improvement in adhesion performance was observed in the ink-curing method involving UV+heating in comparison to the ink-curing method involving UV only. However, the results cannot be tolerated for practical use except an instance in which the ink-curing method using UV+heating has been used for the test example 7-1.

Next, a description will be given for results of the comparative evaluation in relation to abrasion resistance. The evaluation method and evaluation criteria are identical to those described with reference to Table 1; therefore, a description shall not be given, and only the results will be described. As can be seen from the evaluation results shown in Table 2, in the test example 5-1, the abrasion resistance is evaluated as D in the ink-curing method involving UV only, but improves to an evaluation of C in the ink-curing method involving UV+heating. Similarly, the adhesion performance evaluation remained from C to C in the test example 6-1, improved from C to B in the test example 7-1, improved from C to B in the test example 8-1, and remained from D to D in the comparative example 2-1. In other words, in each of the test examples and the comparative example, a moderate improvement in adhesion performance was observed in the ink-curing method involving UV+heating in comparison to the ink-curing method involving UV only. However, the results cannot be tolerated for practical use except an instance in which the ink-curing method using UV+heating has been used for the test example 7-1 and the test example 8-1.

Next, a description will be given for results of the comparative evaluation in relation to alcohol resistance. The evaluation method and evaluation criteria are identical to those described with reference to Table 1; therefore, a description shall not be given, and only the results will be described. As can be seen from the evaluation results shown in Table 2, in the test example 5-1, the alcohol resistance is evaluated as D in the ink-curing method involving UV only, and remains at an evaluation of D in the ink-curing method involving UV+heating. The adhesion performance evaluation improved from D to C in the test example 6-1, improved from C to B in the test example 7-1, remained from C to C in the test example 8-1, and remained from D to D in the comparative example 2-1. In other words, in each of the test examples and the comparative example, a moderate improvement in alcohol resistance was observed in the ink-curing method involving UV+heating in comparison to the ink-curing method involving UV only. However, the results cannot be tolerated for practical use except an instance in which the ink-curing method using UV+heating has been used for the test example 7-1.

In other words, it was found that in each of the inks, although it is possible to observe both the effect of the ink containing 5 wt % or more of N-vinyl caprolactam (NVC) and the effect of using a curing method in which heating is performed in addition to UV irradiation, a sufficient effect cannot be obtained by merely applying irradiation of the UV light 41 at a cumulative light dose of 200 mJ/cm² or less, compared to an instance in which irradiation of the UV light 41 is applied at a cumulative light dose equal to or greater than 200 mJ/cm². The results showed that from amongst the inks, the ink shown by the test example 7-1, which is the ink 45 used for marking the semiconductor chips 12, is the only ink evaluated as B for adhesion performance, abrasion resistance, and alcohol resistance under conditions shown in Table 2.

Thus, in Tables 1 and 2, the markings treated using the ink-curing method involving UV+heating in the test example 1-1, the test example 2-1, the test example 3-1, the test example 4-1, and the test example 7-1 have a quality that is sufficient for practical use (at least an evaluation of B). The instance of the test example 3-1 in particular was evaluated as A in all of the evaluations. This shows that a treatment in which the ink 45 contains N-vinyl caprolactam (NVC), and in which curing is performed by irradiation by the UV light 41 and heating, is effective. To repeat, the ink 45 contains N-vinyl caprolactam (NVC) at 15 wt %, which is greater than 5 wt %, and is set so as to be cured by irradiation by the UV light 41 from the irradiation devices 15 at a cumulative light dose equal to or greater than 200 mJ/cm² and by heating using the hotplate at 180° C., which is within a range of 150 to 200° C. Therefore, it is possible to avoid, e.g., the effect of heat on the semiconductor chips 12 including the package comprising an epoxy resin or another substance when the ink 45 is being cured, and maintain the performance of the semiconductor chips 12 intact. The ink 45 also has excellent characteristics in terms of all of the adhesion performance, abrasion resistance, and alcohol resistance, and is most suitable for marking the semiconductor chips 12.

### Second Embodiment

Next, a description will be given for another embodiment in relation to marking in which a variety of types of ink including the ink 45 are used. Table 3 shows results of a comparative evaluation of an instance in which 5 types of ink, each containing compositions at 5 different proportions, are irradiated with the UV light 41 so that curing is obtained at a curing ratio equal to or greater than 95% (UV only), and an instance in which the 5 types of ink are irradiated with the UV light 41 so that curing is obtained at a curing ratio equal to or greater than 95% and heated at 180° C. (UV+heating), in the curing treatment step (steps S3 through S6 and S8 through S11) shown in FIG. 4. The comparative evaluation indicates the adhesion performance, abrasion resistance, and alcohol resistance of the ink.

TABLE 3
Curing ratio equal to or greater than 95%

| | | | | | | Comparative |
|---|---|---|---|---|---|---|
| | | Test example 1-2 | Test example 2-2 | Test example 3-2 | Test example 4-2 | example 1-2 |
| Main | NVC | 5.0 | 100.0 | 15.0 | 20.0 | 3.0 |
| composi- | VEEA | 50.0 | 40.0 | 20.0 | 30.0 | 33.0 |
| tion of test | PET3A | 11.6 | 5.0 | 18.0 | 10.0 | 5.0 |
| ink (wt %) | PEA | 2.0 | 13.6 | 15.6 | 3.6 | 27.6 |

| | | | | | | | | | | |
|---|---|---|---|---|---|---|---|---|---|---|
| Ink curing | UV | UV + | UV | UV + | UV | UV + | UV | UV + | UV | UV + |
| | only | heating | only | heating | only | heating | only | heating | only | heating |
| Adhesive property | C | B | B | A | B | B | B | B | D | C |
| Abrasion resistance | B | A | B | A | C | B | C | B | C | C |
| Alcohol resistance | B | A | B | A | B | B | B | B | D | C |

As shown in Table 3, five types of test ink, for test examples 1-2 through 4-2 and comparative example 1-2, were prepared and evaluated. The N-vinyl caprolactam (NVC), which is a required polymerisable compound in the present embodiment, is contained at 5 wt % in the ink used in the test example 1-2, at 10 wt % in the ink used in the test example 2-2, at 15 wt % in the ink used in the test example 3-2, at 20 wt % in the ink used in the test example 4-2, and at 3 wt % in the ink used in the comparative example 1-2. Some of the other compositions, such as 2-(vinyloxyethoxy)ethyl acrylate (VEEA), are also shown as reference. The method for curing the inks was divided into the method involving UV only and the method involving UV+heating; and a comparative evaluation was performed on each of the methods.

First, a description will be given for results of a comparative evaluation in relation to adhesion performance. The adhesion performance was evaluated so as to conform to JIS K-5600-5-6 (ISO2409) (Testing Methods for Paints—Part 5: Mechanical Property of Film—Section 6: Adhesion Test (Cross-Cut Test)). The performance of adhesion between the surface of a semiconductor chip 12 and a marking drawn on the surface was evaluated. According to the cross cut test, first, a single-bladed cutting tool, as a cutting tool (a common commercially available cutter) and a guide for guiding the single-bladed cutting tool so that incisions can be made at equal intervals, were readied. The blade of the cutting tool was applied so as to be orthogonal to the film of the marking, and six incisions were made. After the six incisions have been made, the orientation was changed by 90°, and six more incisions were made so as to be perpendicular to the incisions already made. Next, a transparent adhesive tape (width 25±±1 mm) was prepared so as to have a length of approximately 75 mm, the tape was pasted on the portion of the film that has been cut in a grid pattern, and the tape was rubbed well using a finger so that the film becomes visible through the tape. Next, within 5 minutes of the tape being pasted, the tape was completely peeled over 0.5 seconds to 1.0 second at an angle near 60° relative to the film.

Criteria for evaluation of the adhesion performance performed as described above are as follows. A and B represent evaluation criteria that can be tolerated for practical use.

A: No peeling in any grid cell.

B: Peeling observed in some grid cells.

C: Peeling observed in 50% or more grid cells.

D: Peeling observed throughout.

As can be seen in the evaluation results shown in Table 3, in test example 1-2, the adhesion performance is evaluated as C in the ink-curing method involving UV only, but improves to an evaluation of B in the ink-curing method involving UV+heating. Similarly, the adhesion performance evaluation improved from B to A in the test example 2-2, remained from B to B in the test example 3-2, remained from B to B in the test example 4-2, and improved from D to C in the comparative example 1-2. In other words, in each of the test examples and the comparative example, an improvement in adhesion performance was observed in the ink-curing method involving UV+heating in comparison to the ink-curing method involving UV only. However, for the comparative example 1-2, the results cannot be tolerated for practical use, even when an ink-curing method using UV+heating has been used.

Next, a description will be given for results of a comparative evaluation in relation to abrasion resistance. For the abrasion resistance, a variable-load friction-and-wear testing system (e.g., Tribogear TYPE-HHS2000 (commercial name); Shinto Scientific, Co., Ltd) was used to observe the degree of peeling of the marking film. As for the condition, the marking film was scratched using a sapphire needle measuring 0.2 mm in diameter using a constant load, and the degree of peeling of the film was observed.

Criteria for evaluation of the abrasion resistance performed as described above are as follows. A and B represent evaluation criteria that can be tolerated for practical use.

A: No damage or peeling of film.

B: Some damage on film, but no peeling observed.

C: Some damage on film, and peeling of film observed.

D: Damage on film throughout, and peeling of film observed.

As can be seen in the evaluation results shown in Table 3, in test example 1-2, the abrasion resistance is evaluated as B in the ink-curing method involving UV only, but improves to an evaluation of A in the ink-curing method involving UV+heating. Similarly, the abrasion resistance evaluation improved from B to A in the test example 2-2, improved from C to B in the test example 3-2, improved from C to B in the test example 4-2, and remained from C to C in the comparative example 1-2. In other words, in each of the test examples and the comparative example, an improvement in the abrasion resistance was observed in the ink-curing method involving UV+heating in comparison to the ink-curing method involving UV only. However, for the comparative example 1-2, the results cannot be tolerated for practical use, as with the adhesion performance.

Next, a description will be given for results of a comparative evaluation in relation to alcohol resistance. For the alcohol resistance, a marking on a semiconductor chip 12 was immersed for one minute in an isopropyl alcohol solution and then removed from the solution, and the degree of peeling of the marking was observed using a similar condition as that according to the abrasion resistance evaluation already described.

Criteria for evaluation of the alcohol resistance performed as described above are as follows. A and B represent evaluation criteria that can be tolerated for practical use.

A: No damage or peeling of film.

B: Some damage on film, but no peeling observed.

C: Some damage on film, and peeling of film observed.

D: Damage on film throughout, and peeling of film observed.

As can be seen in the evaluation results shown in Table 3, in test example 1-2, the alcohol resistance is evaluated as B in the ink-curing method involving UV only, but improves to an evaluation of A in the ink-curing method involving UV+heating. The alcohol resistance evaluation also improved from B to A in the test example 2-2, remained from B to B in the test example 3-2, remained from B to B in the test example 4-2, and improved from D to C in the comparative example 1-2. In other words, in each of the test examples and the comparative example, an improvement in the alcohol resistance was observed in the ink-curing method involving UV+heating in comparison to the ink-curing method involving UV only. However, for the comparative example 1-2, the results cannot be tolerated for practical use, as with the adhesion performance and abrasion resistance.

The results for the comparative example 1-2 are results that cannot be tolerated in regards to adhesion performance, abrasion resistance, and alcohol resistance. It can be determined that this is caused by the content of the N-vinyl caprolactam (NVC) in the ink being 3 wt %. Accordingly, it can be said that the content of the N-vinyl caprolactam (NVC) in the ink is preferably equal to or greater than 5 wt %. The ink 45 used in the marking device 1 is the ink evaluated in the test example 2-2. The results show that the ink 45 used for marking the semiconductor chips 12 has, if treated using the ink-curing method involving UV+heating, an evaluation of A for all of adhesion performance, abrasion resistance, and alcohol resistance, and has excellent characteristics.

Next, a description will be given for evaluation results for instances in which, in relation to marking in which the ink 45 is used, a curing method in which the UV light irradiation condition is different is applied to five types of ink having compositions similar to those shown in Table 3. The curing method is different in that irradiation by UV light 41 is applied so that curing is achieved to a curing ratio of 90% in the irradiation step (steps S3 through S6 and S8 through S11) shown in FIG. 4. A divergence with respect to an instance in which the irradiation by UV light 41 is applied so that curing is achieved to a curing ratio equal to or greater than 95% is thereby identified. Table 4 shows results of a comparative evaluation of an instance in which the 5 types of ink are irradiated with the UV light 41 so that curing is achieved to a curing ratio of 90% (UV only), and an instance in which the 5 types of ink are irradiated with the UV light 41 so that curing is achieved to a curing ratio of 90% and heated at 180° C. (UV+heating). The comparative evaluation indicates the adhesion performance, abrasion resistance, and alcohol resistance of the ink. The ink used in each of test examples 5-2, 6-2, 7-2, and 8-2 and comparative example 2-2 in Table 4 are the same as that used in each of test examples 1-2, 2-2, 3-2, and 4-2, and comparative example 1-2 in Table 3, respectively.

TABLE 4

| | | | | | | Comparative |
|---|---|---|---|---|---|---|
| | | Test example 5-2 | Test example 6-2 | Test example 7-2 | Test example 8-2 | example 2-2 |
| Main | NVC | 5.0 | 100.0 | 15.0 | 20.0 | 3.0 |
| composi- | VEEA | 50.0 | 40.0 | 20.0 | 30.0 | 33.0 |
| tion of test | PET3A | 11.6 | 5.0 | 18.0 | 10.0 | 5.0 |
| ink (wt %) | PEA | 2.0 | 13.6 | 15.6 | 3.6 | 27.6 |

| | | | | | | | | | | |
|---|---|---|---|---|---|---|---|---|---|---|
| Ink curing | UV | UV + | UV | UV + | UV | UV + | UV | UV + | UV | UV + |
| | only | heating | only | heating | only | heating | only | heating | only | heating |
| Adhesive property | C | C | C | B | C | C | C | C | D | C |
| Abrasion resistance | C | B | C | B | C | B | C | C | C | C |
| Alcohol resistance | C | B | C | B | C | C | C | C | D | C |

First, a description will be given for results of the comparative evaluation in relation to adhesion performance. The evaluation method and evaluation criteria are identical to those described with reference to Table 3; therefore, a description shall not be given, and only the results will be described. As can be seen from the evaluation results shown in Table 4, in the test example 5-2, the adhesion performance is evaluated as C in the ink-curing method involving UV only, and evaluated as C in the ink-curing method involving UV+heating. The adhesion performance evaluation improved from C to B in the test example 6-2, remained from C to C in the test example 7-2, remained from C to C in the test example 8-2, and improved from D to C in the comparative example 2-2. In other words, in each of the test examples and the comparative example, a moderate improvement in adhesion performance was observed in the ink-curing method involving UV+heating in comparison to the ink-curing method involving UV only. However, the results cannot be tolerated for practical use except an instance in which the ink-curing method using UV+heating has been used for the test example 6-2.

Next, a description will be given for results of the comparative evaluation in relation to abrasion resistance. The evaluation method and evaluation criteria are identical to those described with reference to Table 3; therefore, a description shall not be given, and only the results will be described. As can be seen from the evaluation results shown in Table 4, in the test example 5-2, the adhesion performance is evaluated as C in the ink-curing method involving UV only, but improves to an evaluation of B in the ink-curing method involving UV+heating. The adhesion performance evaluation improved from C to B in the test example 6-2, improved from C to B in the test example 7-2, remained from C to C in the test example 8-2, and remained from C to C in the comparative example 2-2. In other words, in each of the test examples and the comparative example, a moderate improvement in adhesion performance was observed in the ink-curing method involving UV+heating in comparison to the ink-curing method involving UV only. However, the results cannot be tolerated for practical use except an instance in which the ink-curing method using UV+heating has been used for the test example 5-2, the test example 6-2, and the test example 7-2.

Next, a description will be given for results of the comparative evaluation in relation to alcohol resistance. The evaluation method and evaluation criteria are identical to those described with reference to Table 3; therefore, a description shall not be given, and only the results will be described. As can be seen from the evaluation results shown in Table 4, in the test example 5-2, the adhesion performance is evaluated as C in the ink-curing method involving UV only, but improves to an evaluation of B in the ink-curing method involving UV+heating. The adhesion performance evaluation improved from C to B in the test example 6-2, remained from C to C in the test example 7-2, remained from C to C in the test example 8-2, and improved from D to C in the comparative example 2-2. In other words, in each of the test examples and the comparative example, a moderate improvement in alcohol resistance was observed in the ink-curing method involving UV+heating in comparison to the ink-curing method involving UV only. However, the results cannot be tolerated for practical use except an instance in which the ink-curing method using UV+heating has been used for the test example 5-2 and the test example 6-2.

In other words, it was found that in each of the inks, although it is possible to observe both the effect of the ink containing 5 wt % or more of N-vinyl caprolactam (NVC) and the effect of using a curing method in which heating is performed in addition to UV irradiation, a sufficient effect cannot be obtained by merely applying irradiation of the UV light 41 so that curing is obtained at a curing ratio of 90%, compared to an instance in which irradiation of the UV light 41 is applied so that curing is obtained at a curing ratio equal to or greater than 95%. The results showed that from amongst the inks, the ink shown by the test example 6-2, which is the ink 45 used for marking the semiconductor chips 12, is the only ink evaluated as B for all of the adhesion performance, abrasion resistance, and alcohol resistance under conditions shown in Table 4.

Thus, in Tables 3 and 4, the markings treated using the ink-curing method involving UV+heating in the test example 1-2, the test example 2-2, the test example 3-2, the test example 4-2, and the test example 6-2 have a quality that is sufficient for practical use (at least an evaluation of B). The instance of the test example 2-2 in particular evaluated as A in all of the evaluations. This shows that a treatment in which the ink 45 contains N-vinyl caprolactam (NVC), and in which curing is performed by irradiation by the UV light 41 and heating, is effective. To repeat, the ink 45 contains N-vinyl caprolactam (NVC) at 10 wt %, which is greater than 5 wt %, and is set so as to be cured by irradiation by the UV light 41 from the irradiation devices 15 so that curing is obtained at a curing ratio equal to or greater than 95% and by heating using the hotplate at 180° C., which is within a range of 150 to 200° C. Therefore, it is possible to avoid, e.g., the effect of heat on the semiconductor chips 12 including the package comprising an epoxy resin or another substance when the ink 45 is being cured, and maintain the performance of the semiconductor chips 12 intact. The ink 45 also has excellent characteristics in terms of all of the adhesion performance, abrasion resistance, and alcohol resistance, and is most suitable for marking the semiconductor chips 12.

The method for manufacturing, the method for marking, and the device for marking an electronic component are not limited to the above-mentioned embodiments. Effects similar to the embodiments can be obtained using a configuration such as that in a modification example described as follows.

### First Modification Example

The heating step (step S15) is configured so that in the heating position of the marking device 1, the semiconductor chips 12 on which markings have been drawn are arranged on a hotplate and heated. However, this configuration is not provided by way of limitation. For example, as shown in FIG. 2, a mercury lamp, a metal halide lamp, or another heating lamp (heating part) 80 may be used, where the heating temperature is set to 150 to 200° C., and preferably to 180° C. The heating step may also be performed using a device other than the marking device 1, as with the surface treatment step.

### Second Modification Example

A setup is present in which the surface treatment step is performed on the semiconductor chips 12 using a device other than the marking device 1. However, a configuration is also possible in which the marking device 1 comprises an activating part for applying heating under an atmosphere for performing the surface treatment, and the surface treatment step is performed through a control performed by the control part 6.

### Third Modification Example

The work 10 has a placement platform 11 and a semiconductor chips 12, which is an electronic component placed on the placement platform 11. However, it is also possible to omit the placement platform 11 and position only the electronic component, as a member to be processed, on the work table 25.

### Fourth Modification Example

An electronic component marked using the ink 45 is not limited to the semiconductor chips 12. Other applications include, e.g., USB memory devices, memory cards, SD memory cards, memory sticks, SmartMedia, XD picture cards, and other flash memory cards; packaged oscillators; and other components.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method for manufacturing an electronic component comprising:
applying a liquid body onto an electronic component to perform marking, the liquid body having a light-curing property and containing 5 wt % or more of N-vinyl caprolactam;
irradiating light on the liquid body applied onto the electronic component at a cumulative light dose equal to or greater than 200 mJ/cm²; and
heating the liquid body after the irradiating of the light.

2. The method for manufacturing an electronic component according to claim 1, wherein
the heating of the liquid body includes heating the liquid body at a temperature of 150 to 200° C.

3. The method for manufacturing an electronic component according to claim 1, wherein
the liquid body contains N-vinyl caprolactam at a range of 5 to 20 wt %.

4. The method for manufacturing an electronic component according to claim 1, further comprising
performing a surface treatment of the electronic component by activating a surface of the electronic component before the applying of the liquid body onto the electronic component.

5. A method for manufacturing an electronic component comprising:
applying a liquid body onto an electronic component to perform marking, the liquid body having a light-curing property and containing 5 wt % or more of N-vinyl caprolactam;
curing the liquid body applied onto the electronic component to a curing ratio equal to or greater than 95% by irradiating light on the liquid body; and
heating the liquid body after the curing of the liquid body.

6. The method for manufacturing an electronic component according to claim 5, wherein
the heating of the liquid body includes heating the liquid body at a temperature of 150 to 200° C.

7. The method for manufacturing an electronic component according to claim 5, wherein
the liquid body contains N-vinyl caprolactam at a range of 5 to 20 wt %.

8. The method for manufacturing an electronic component according to claim 5, further comprising
performing a surface treatment of the electronic component by activating a surface of the electronic component before the applying of the liquid body onto the electronic component.

9. A marking method comprising:
applying a liquid body onto a member to be processed to perform marking, the liquid body having a light-curing property and containing 5 wt % or more of N-vinyl caprolactam;
irradiating light on the liquid body applied to the member to be processed at a cumulative light dose equal to or greater than 200 mJ/cm²; and
heating the liquid body after the irradiating of the light.

10. A marking method comprising:
applying a liquid body onto a member to be processed to perform marking, the liquid body having a light-curing property and containing 5 wt % or more of N-vinyl caprolactam;
curing the liquid body applied to the member to be processed to a curing ratio equal to or greater than 95% by irradiating light on the liquid body; and
heating the liquid body after the curing of the liquid body.

11. A marking device comprising:
an ejecting part configured and arranged to eject, onto a member to be processed, a liquid body having a light-curing property and containing 5 wt % or more of N-vinyl caprolactam; and
an irradiation part configured and arranged to irradiate light on the liquid body ejected onto the member to be processed at a cumulative light dose equal to or greater than 200 mJ/cm².

12. The marking device according to claim 11, further comprising
a heating part configured and arranged to heat the liquid body after the liquid body is cured.

13. A marking device comprising:
an ejecting part configured and arranged to eject, onto a member to be processed, a liquid body having a light-curing property and containing 5 wt % or more of N-vinyl caprolactam; and
a curing treatment part configured and arranged to irradiate light on the liquid body applied to the member to be processed to perform curing of the liquid body to a curing ratio equal to or greater than 95%.

14. The marking device according to claim 13, further comprising
a heating part configured and arranged to heat the liquid body after the liquid body is cured.
